(19) United States
(12) Patent Application Publication
(10) Pub. No.: US 2004/0131059 A1
(43) Pub. Date: Jul. 8, 2004

(54) Single-pass packet scan

(76) Inventors: Ram Ayyakad, Freehold, NJ (US); Krishna Hebbatam, Edison, NJ (US); Alexander Pavlovsky, Morganville, NJ (US); Sampath Rangarajan, Bridgewater, NJ (US); Alexander Sarin, Freehold, NJ (US); Venkata Chinni, Morganville, NJ (US); Anand Kagalkar, Edison, NJ (US)

Correspondence Address: William Ryan, Attorney at Law, Suite 360, 1253 Springfield Avenue, New Providence, NJ, 07974, US

(21) Appl. No.: 10/667,218

(22) Filed: Sep. 19, 2003

Related U.S. Application Data
(60) Provisional application No. 60/412,099, filed on Sep. 19, 2002.

(51) Int. Cl. H04L 12/56

(52) U.S. Cl. 370/389; 370/252

(57) ABSTRACT

In illustrative embodiments, equivalent network processing of packets is performed at a single node instead of at a large number of special purpose nodes. A single-pass pipelined packet scan at the single node permits required actions to be taken in an integrated manner to avoid repetitive processing. Processing is conveniently accomplished in separate stateless and stateful segments, with state-related information derived during the stateless packet scan segment tagged to processed packets as required for subsequent stateful processing.

### RELATED APPLICATIONS

This application is related to U.S. patent applications:

(i) Ser. No. 10/299,365, filed Nov. 18, 2002;

(ii) Ser. No. 10/307,839, filed Dec. 2, 2002;

(iii) Ser. No. 10/315,206, filed Dec. 2, 2002;

(iv) that application entitled Creation and Control of Managed Zones, filed Sep. 17, 2003; and

(v) Provisional application 60/412,099 filed Sep. 19, 2002 Each of these applications is owned by the owner of the present application and is hereby incorporated by reference in the present application.

### CLAIM OF PRIORITY

This application claims priority based on the above-cited provisional application 60/412,099 filed Sep. 19, 2002.

### FIELD OF THE INVENTION

The present invention relates to packet communications networks, including networks for processing packets and packet streams subject to rules, policies, actions and conditions in such networks. More particularly, the present invention relates to methods and systems for examining received packets with respect to header and other content and processing packets subject to applicable rules, policies, actions and conditions. Still more particularly, the present invention relates to an architectural innovation in the examination and processing of packets at a location and/or in a single pass through a networking stack.

### BACKGROUND OF THE INVENTION

Modern data networks are usually described in terms of a plurality of nodes interconnected by communication links. Nodes may be of many different types, including user terminals, computers, access nodes of various kinds, switches, routers and specialty servers of many kinds—among many other types. Nodes may be physically or logically grouped into local or distributed sub-networks at many hierarchical grouping levels, e.g., local area networks (LANs), wide area networks (WANs) and many other organizations known in the communications arts. Likewise, communication links may be wired or wireless and may employ any of a wide variety of transmission media.

A number of communications protocols and conventions have been defined and standardized to help provide for the orderly communication of information. For example it is common to refer to layers of a communications protocol in terms of the seven-layer International Standards Organization (ISO) reference model and similar models adopted by the International Telecommunications Union (ITU) and others. See, for example, D. Bertsekas and R. Gallager, Data Networks, Prentice-Hall, 1987, especially pages 14-26, for a more detailed description of these layered models and associated network processing.

Operations performed by individual network nodes are typically associated with such layers, with processing at layers for a given node being collected as a protocol stack. For example, network routers are usually associated with Layer 3 (L3) operations, while certain switching functions are performed at Layers 3 and Layer 4 (L3 and L4). Internet communications is conducted using the well-known TCP/IP protocol, with IP communications functions associated largely with Layer 3, and TCP functions associated largely with Layer 4. Generally, higher layer processing (e.g., session and application) is associated with increasingly abstract and less physical processing.

FIG. 1 shows one representation of the well-known ISO model with commonly associated layer identification shown. In some contexts different characterizations of layers is employed, but the overall layering plan remains valid.

As shown in FIG. 1, host 100 (e.g., an end user terminal) communicating bi-directionally with host 130 (e.g., a World Wide Web (WWW) server) sends and receives packets over physical links 105, 115 and 125 while passing through intermediate nodes 110 and 120. Processing at hosts 100 and 130 will illustratively use transport (L4), application (L7) and other higher level layers, while intermediate nodes 110 and 120 illustratively process packets only at L1, L2 and L3. If an intermediate node provides higher layer processing, e.g., firewall processing, then the protocol stack for that node will include at least L4 processing.

Processing at network nodes is often characterized as being stateful or stateless. This distinction refers to the presence or absence, respectively, of memory for storing state information from external sources or from prior processing. Thus, firewall processing can be said to be stateless if it relies only on examination (subject to prescribed rules) of each current packet as it arrives at a firewall node. By way of distinction, some firewall processing is said to be stateful if it caches processing rule results for some packets, and then uses the cached results to bypass such rule processing for subsequent similar packets. See, for example, U.S. Pat. No. 6,170,012 issued Jan. 2, 2001.

In general, all network processing functions can be categorized as stateful or stateless, and, as shown above, some categories of processing (e.g., firewall processing) can be either—depending on circumstances, such as the level of potential vulnerability to malicious intrusion. The number of existing and future network functions that require specialized processing is potentially very large, though each such function is typically carefully defined and often formalized in an industry standard. In some cases, proprietary processing techniques are employed, but these are nevertheless well defined, though subject to appropriate access authorization.

As appears from even the simplified presentation of FIG. 1, traditional packet network processing is largely sequential. That is, packets are transferred from node to node with appropriate processing applied at a particular node before an outgoing transfer is made to a following node. A closer examination of many of individual processing functions makes clear that prior techniques require repeatedly performing certain processing steps over and over. Thus, for example, if a firewall function is to be performed at a given node, information such as the packet destination address may well be examined. This same processing step may well be applied while performing a load balancing function in support of a server cluster. Existing network processing techniques therefore prove inefficient in requiring that predictable processing steps occurring in different individual network processes be repeated as each network process is separately performed.

Current distributed special function network devices, such as firewalls, load balancers and the like are frequently expensive, limited-function units (often referred to as middleware boxes), devices that provide little flexibility and prove more difficult to configure and maintain.

A need therefore exists to avoid unnecessary duplication of processing steps, thereby providing increased throughput and reduced likelihood of processing errors. A need also exists to provide network devices with increased flexibility in functionality and configurability.

### SUMMARY OF THE INVENTION

Limitations of the prior art are overcome and a technical advance is made in accordance with the present invention described in illustrative embodiments herein.

In accordance with one illustrative embodiment, network processing of packets is performed at a reduced number of nodes, thereby avoiding repeated performance of identical steps common to two or more network functions.

In preferred embodiments, it is possible to use a single network device at a single network node to perform functions traditionally performed at a large number of nodes. Illustrative embodiments advantageously employ a plurality of functional modules, each module being adapted to perform a specified function or a number of such functions. When the results of combined processing in accordance with such embodiments are to be applied to a currently examined packet (e.g., rejection of a packet by a firewall function), then the results are advantageously applied immediately. When the single functional module is used to derive results are to be applied at a downstream module at the single location, it proves convenient to augment information associated with the examined packet to reflect the results of processing. This augmented information in the form of a flow record is then available for later use at the downstream module.

Particular embodiments of the present invention illustratively comprise separately processing stateless and stateful network functions in respective device segments while employing pipelining techniques to share both processing resources and intermediate processing results as needed. Thus, e.g., particular header information, once extracted from a packet, can be used in performing several pipelined functions, thereby avoiding redundant packet-examining steps. Information derived from external sources, such as contract information, that is available to stateless processing modules is advantageously appended to packets as a flow record for later use by stateful processing modules, and processing steps employed in such stateful modules.

Since the present inventive architecture advantageously integrates a number of network functions at a single location, and since illustrative embodiments of the single-location architecture are advantageously implemented in program-controlled processors, additions or deletions of particular functions may be made with high efficiency. That is, by merely invoking a particular software module, it is possible to add or delete one or more network function, e.g., a firewall function. Likewise, when particular functionality is implemented as a Field Programmable Gate Array (FPGA) or as an Application Specific Integrated Circuit (ASIC), a simple enabling signal can be applied by a system operator.

Similarly, newly defined network functions are readily added at the single-location traffic management device in illustrative embodiments. In similar manner, particular network functions can be tailored or reconfigured to meet the needs of particular network users, or classes of users. Thus, one particular version of a firewall function may be applied for one class of users, and a different (or differently configured) version of a firewall may be made available for use with packets of another user or class of users. Similar selections are readily made for other particular functions, including those described below.

Invoking of a software module or enabling of a FPGA, ASIC or other particular hardware or software module can be effected locally by a system administrator in well-known fashion or may be accomplished remotely by sending appropriately coded packets to a single-location integrated traffic management device itself for interpretation and configuration purposes. New network functions are readily added by providing appropriate new control programs or hardware modules. Again, new or modified software modules are conveniently delivered to the inventive integrated management device via packets delivered to this integrated device as a destination.

Use of the present inventive teachings permits a more efficient handling of network traffic and a reduction in the operational complexity of the network. In avoiding redundant packet processing steps, embodiments of the present reduce the potential for processing errors and consequent retransmission requirements.

### BRIEF DESCRIPTION OF THE DRAWING

The above-summarized description of illustrative embodiments of the present invention will be more fully understood upon a consideration of the following detailed description and the attached drawing, wherein:

FIG. 1 is a representation of the well-known ISO model used in layered network processing generally.

FIG. 2A is a diagram illustrating a typical illustrative data network, including a plurality of processing nodes.

FIG. 2B is a network device in accordance with illustrative embodiments of the present invention for integrating the functions of processing nodes shown in FIG. 2A into a single processing node.

FIG. 2C shows an exemplary version of a data packet augmented with a flow record in accordance with an aspect of illustrative embodiments of the present invention.

FIG. 3 is a more detailed representation of the network device of FIG. 2B showing illustrative partitioning of functions into stateful and stateless functional modules.

FIG. 4 shows an alternative processing module organization featuring a plurality of stateful processors.

### DETAILED DESCRIPTION

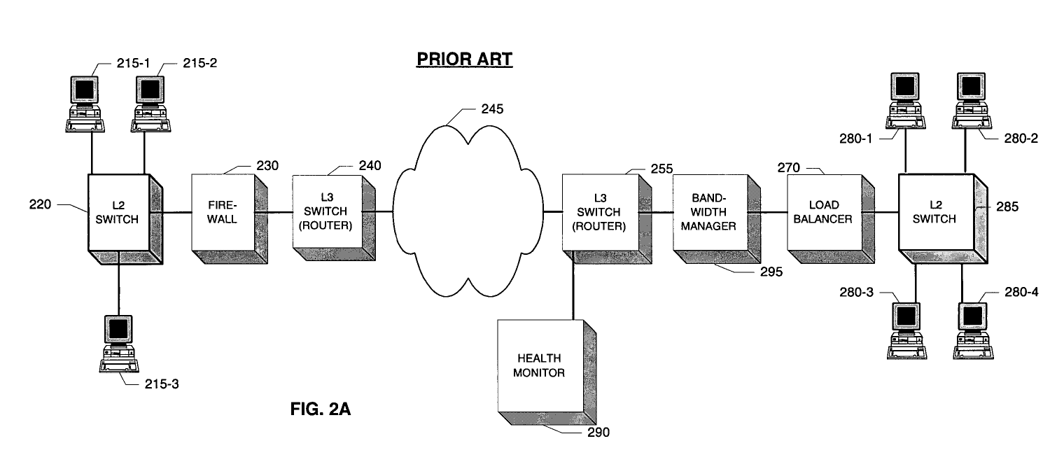

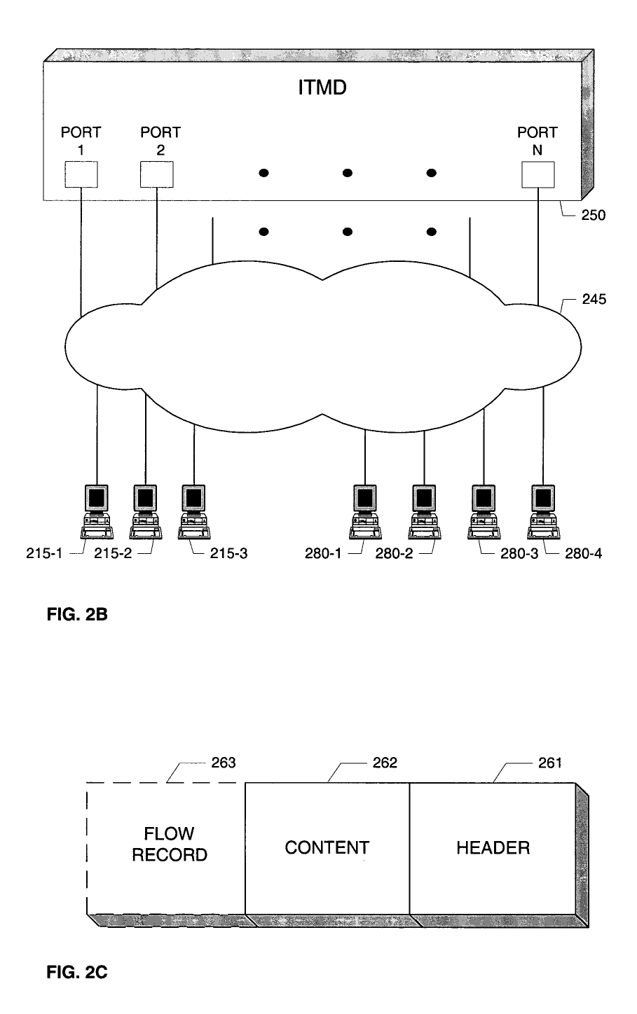

The present detailed description will be presented in the illustrative context of a typical network topology such as that of an organization seeking to meet the requirements of its Intranet and/or Internet users. Such a network typically comprises equipment such as L3/L4 switches, firewalls, bandwidth managers, network health managers and load balancers. The end-to-end traffic flow in such a network organization passes through the networking stacks of many so-called middleware devices, each of which applies specific rules, policies and actions to the passing packets. A representative portion of such a network is shown in FIG. 2A.

In particular, FIG. 2A shows a number of network nodes illustratively comprising user workstations or terminals 215-i connected via L2 switch 220, or alternatively in the form of a specific type of local area network (LAN). From L2 switch 220 packets to and from nodes 215-i illustratively pass through firewall 230 and L3 switch/Router 240 to/from other (unspecified) portions of the network represented by cloud 245. Also shown connected to network cloud 245 is L3 switch/Router 255, which, in turn is connected to health monitor 290 and bandwidth manager 295. Bandwidth manager 295, in turn, is connected to load balancer 270, which is shown supporting an illustrative plurality of servers 280-j through L2 switch/LAN 285.

Each of the elements of the network of FIG. 2A is well known and performs individually well-known functions. Load balancer 270 provides for balancing of loads between the plurality of servers running network applications, such as web page servers, database servers or any other kind of server function. Health monitors such as 290 shown in FIG. 2A typically collect and provide information on extent of use and operating parameters, e.g., errors, on interfaces attached to managed hubs, managed switches, routers, servers, firewalls, network printers, and other network devices.

In accordance with an illustrative embodiment of the present invention shown in FIG. 2B, a single multi-functional network processing device 250 enables enforcement of all specific rules, policies and actions to packets that are performed by the arrangement of stand-alone network elements shown in FIG. 2A. As will be described in detail below, the network device 250 shown in FIG. 2B advantageously provides the required processing functions at a single processing node. It will be recognized that the cloud 245 as shown in FIG. 2B is shown directly connected to the illustrative end-user nodes 215-i and servers 280-j shown in FIG. 2A.

Pipelined processing techniques are advantageously applied in enabling the single processing engine 250 in the system of FIG. 2B to perform its multiple required functions in a single pass of packets through its networking stack. These inventive techniques facilitate more efficient handling of traffic and reduce network operational complexity.

From a consideration of the individual functional elements in the network of FIG. 2A it will be appreciated that the processing engine 250 of FIG. 2B integrates the functionality of many different middleware nodes. Processing engine 250 shown in FIG. 2B provides functionalities provided in less efficient form by the collection of stand-alone middleware nodes shown in FIG. 2A, but not expressly present in FIG. 2B. For convenience of reference, the processing device 250 of FIG. 2B will be referred to in this detailed description as Integrated Traffic Management Device (ITMD). The illustrative organization and operation of ITMD will be seen to integrate the functionality of separate middleware boxes including: L3/L4 switches, firewalls, application load balancers, service health monitors, and bandwidth managers. While these functions are described by way of example, it will be appreciated by those skilled in the art that a great variety of network functionalities will be realized in a common processing engine in accordance with the present inventive teachings. In achieving its efficient integrated functionality ITMD scans packet content once and then performs multiple functions based, at least in part, on retrieved content.

The different illustrative functionalities that ITMD of FIG. 2B integrates have varying requirements. For instance, L3 switch operates only on the IP header information present in the packet. Similarly a L4 switch operates exclusively on TCP/UDP/ICMP headers. The firewall and bandwidth manager functions require an examination of both the Layer 3 and Layer 4 headers in the packet for classification purposes. The application load balancer and health monitor functions of the ITMD require access to application specific information associated with incoming packets. Some of these functionalities are stateless and allow each packet to be processed independently. Other functionalities are stateful, e.g., those required to maintain the state of individual traffic flows.

A considerable overlap exists in the requirements of many of the functionalities integrated in the ITMD of FIG. 2B and some of the basic processing performed by the individual middleware devices of FIG. 2A. For instance, the classification and flow identification mechanisms used in both are based mostly on L3 and L4 data present in examined packets. Further, all IP network devices are required to perform checksum generation and checking and IP routing as part of their operation. The ITMD capitalizes on this overlap and optimizes performance for all the integrated functionalities.

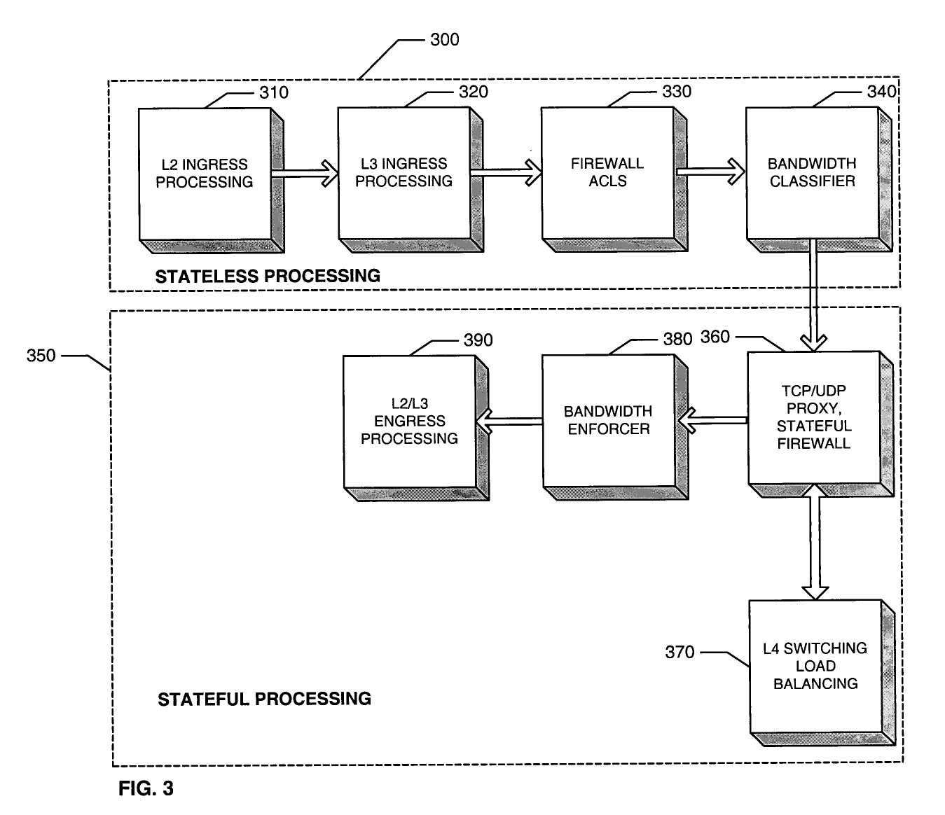

An illustrative embodiment of the inventive ITMD shown in greater detail in FIG. 3 employs a pipelined architecture. In general, the illustrative pipeline of FIG. 3 comprises multiple modules, each performing a dedicated function as a packet moves along the pipeline to the next downstream module. Each module in the pipeline processes packet header information, sometimes modifies the packet, and may drop the packet under certain circumstances. The result of processing in a pipeline module shown in FIG. 3 is sometimes passed to downstream modules by adding an additional “flow record” as a prefix to the packet. It proves advantageous in the design and operation of ITMD to have the pipeline split up into two segments: segment 300 shown in FIG. 3 performs all of the stateless processing and segment 350 performs all of the stateful processing. Typical operation of the pipeline of FIG. 3 will be described further below.

Stateless Processing

Stateless processing in the illustrative pipeline of FIG. 3 comprises a plurality of modules primarily focused on basic packet processing at Layer 2 and Layer 3 (L2 and L3). This basic processing includes essential checking of data integrity and correctness checks of the packet headers. A common feature of all modules in the stateless processing portion of the pipeline is that they operate on a per packet basis and do not maintain any state information. Each of the stateless processing modules will now be described in greater detail.

L2 Ingress Processing Module

The L2 Ingress processing module 310 shown in FIG. 3 performs all L2-related functionality in the Ingress direction. This includes the mapping of an IP address to the proper L2 address. If the layer 2 is Ethernet, this module is responsible for all the ARP related functionality. In addition, this module does the L2 decapsulation and passes the IP packet so obtained to the next module in the pipeline. This module is also responsible for setting and modifying physical layer related parameters and statistics.

L3 Ingress Processing Module

The L3 Ingress processing module 320 shown in FIG. 3 performs all the ingress processing required for IP packets. This includes checking the IP header for any anomalies and IP checksum verification. It also checks whether the examined packet is destined for the ITMD itself—based on a list of IP addresses configured on the ITMD. If not, it determines, based on configuration, whether this packet is to be routed at the L3 layer or switched at the L4 layer. If the packet is to be routed (at L3) and if the packet header indicates that firewalling is not necessary for the packet, it routes the packet to its destination by transmitting the packet on the appropriate output port. Such packets are not forwarded further in the pipeline. If the packet is meant for the ITMD or if it is to be switched at L4 level, it is passed on to the next downstream module, the firewall ACLs module. The L3 module is also responsible for maintaining the IP addresses and the IP forwarding table as in the case of a standard router.

Firewall ACL Module

This module takes care of stateless function of the firewall based on the pre-configured access control lists (ACLs) as for stand-alone firewalls. An ACL rule includes a classification and an action. The classification for each packet is based on various L3/L4 details in the packet, e.g., the source and the destination IP addresses along with optional masks, source and the destination ports expressed as ranges, protocol type, IP TOS field, IP options, TCP options, TCP flags, and ICMP types. The action to be taken for each such class is typically one of the following: accept, deny, forward packet to an external host and copy packet to an external host. The last two actions are used for mirroring selective data to an Intrusion Detection System (IDS).

If the firewall ACL module determines that the packet should be allowed to proceed further, it advantageously performs some additional steps. Thus, if the packet is fragmented, it reassembles the packet and verifies the Layer 4 (TCP/UDP/ICMP) checksum. If the packet is a TCP/UDP packet, it is forwarded to the next module, bandwidth classifier 340 in the pipeline of FIG. 3. Only these latter packets require stateful processing to be subsequently performed by the stateful processing section 350. All other packets that are destined to the ITMD as the end point, including ICMP, RIP, OSPF are handled locally, and are not passed to the downstream modules. If necessary, replies are generated for these packets. All such generated packets are passed directly to the L2/L3 egress-processing module 390.

Bandwidth Classifier Module

The bandwidth manager functionality of the ITMD is split up into two portions, a stateless module (bandwidth classifier 340) and a stateful one (bandwidth enforcer 380). The combined bandwidth manager function uses bandwidth contracts and subcontracts to define contracted bandwidth guarantees and to enforce bandwidth limits. Each contract/subcontract comprises of a set of Min, Burst, and Max values expressed in Mbps and stored in ITMD memory.

In operation of the ITMD, incoming traffic is advantageously classified into different bandwidth contracts/subcontracts. The classification is illustratively determined in accordance with Layer 3 and Layer 4 packet information, including source IP/mask, destination IP/mask, source port or port range and destination port or port range.

A contract may further contain one or more subcontracts. The subcontracts are also based on the L3 and L4 information, but form a subset of the contract. For instance a contract may be specified for all traffic destined to the 192.1.1.0 subnet. With in this subnet, a subcontract may be specified for HTTP traffic destined to this subnet, another subcontract for the FTP traffic and so on.

Bandwidth classifier module 340 examines a received packet to find the classification rule that matches the L3/L4 information present in the packet. Stored rules include the associated contract. Bandwidth classifier 340 also examines L3/L4 information for any subcontracts associated with the contract. The classifier then enters applicable contract and subcontract details into a flow record tagged to the packet that will be used by downstream in the ITMD. In particular, contract enforcement, performed by the bandwidth enforcer module 380 in the stateful segment of the pipeline, uses the tagged flow record provided by bandwidth classifier 340.

Stateful Processing

Functions performed by the stateful processing section 350 in the ITMD of FIG. 3, including the stateful firewall represented by block 360, operate on Layer 4 and the application layer. These modules in section 350 maintain stateful representations of packet traffic in terms of TCP/ICMP flows, UDP streams and application-specific information. These modules are described in detail below.

TCP/UDP/ICMP Proxy Module

Module 360 in FIG. 3 provides TCP/UDP/ICMP switching capability to the ITMD, acts as a TCP/UDP/ICMP proxy and provides stateful firewall functionality. Module 360 functionality includes switching data between any two TCP connections or UDP/ICMP streams at a high speed. This module interacts intensively with L4 switching module 370 in its operation. In terms of the traditional TCP/IP terminology, L4 switching module 370 acts like the application layer entity. In particular, L4 switching module 370 is responsible for setting up a switching matrix for module 360. The switching matrix identifies the two TCP connections or UDP/ICMP streams that are to be switched. The interaction between module 360 and L4 switching module 370 is explained further below. Module 360 also provides firewall protection against all TCP/UDP/ICMP based Denial of Service (DoS) attacks and typically logs all such attacks.

Module 360 advantageously implements a limited TCP end-host functionality. In particular it incorporates functionality to start and terminate TCP connections, and has the ability to bind one connection to the other. It can also check the integrity of TCP headers, verify that header data is within the receive window, and is capable of performing an appropriate level of packet reordering. Module 360 also has the ability to gracefully close TCP connections. It also provides a non-socket based API to L4 switching module 370 for setting up the switching matrix. Module 360 does not, however, implement congestion control and flow control features of TCP.

L4 Switching Module

L4 switching module 370 acts like the application layer for the TCP/UDP proxy module 360, for which it sets up the switching matrix for the proxy module. Whenever proxy module 360 receives a new connection request, it passes the IP/TCP information to the L4 switching module 370. The L4 module 370 then determines whether to accept this new connection or not, based on its configuration. When a new connection is accepted, L4 module 370 also uses setup details regarding the type of network address translation (NAT) to be employed for the connection, as well as the IP address to be used in performing the NAT. The L4 module 370 instructs proxy module 360 to accept this connection, to open a new connection to the NAT IP address and sets up the switching matrix to bind these connections together. In the case of UDP, the above procedure is performed on a per flow basis instead of on a per connection basis.

Module 370 is arranged to perform either Network Address Translation (NAT), Port Address Translation (PAT) or server load balancing for a given connection/flow. NAT rules can be set based on the source IP/mask, destination IP/mask, the IP protocol field, the IP TOS byte and source port or port range and destination port or port range. Any packet that matches a specific rule is switched according to the action specified in the rule. The action can be any one of Half NAT, Full NAT or Reverse NAT, along with the NAT IP address.

NAT is required in networks organized in terms of zones (as described, e.g., in the above-incorporated patent application (iv)) when one of the zones has nodes with private addresses and another zone with public IP addresses, and traffic flows from one zone to the other. NAT can be of different types. If only the destination IP address is mapped to a different address, then it is called Half NAT. If both the source IP address and destination IP addresses are mapped into different addresses, then it is called Full NAT. If only the source IP address is mapped in to another, then it is called Reverse NAT. Depending on the direction of traffic flow, the type of NAT done is different.

To illustrate, let PrZone designate a zone with private IP addresses, and PuZone, designate a zone with public IP addresses. If the traffic originates in the PuZone, and the PrZone does not know how to get back to PuZone, then a Full NAT needs to be done. If the traffic originates in the PuZone and the all the nodes in the PrZone are configured with proper routes to reach the PuZone, and if the nodes in the PrZone need to know the actual source of the traffic, then Half NAT should be used. If the traffic originates on the PrZone, then Reverse NAT should be used.

Load balancing is a mechanism that is used to distribute incoming traffic amongst a group of one or more servers. The incoming traffic that matches a load-balancing rule is distributed fairly between the different servers belonging to the same server group. If the protocol specified is UDP, load balancing can be done on a per flow basis. If TCP is used load balancing is done on a per connection basis. Particular fair load balancing schemes used will include, among many other well-known algorithms, Round Robin, Weighted Round Robin for TCP/UDP and least connections for TCP.

In addition to load balancing and switching, ITMD can also support value-added services such as service health monitoring. In such service monitoring ITMD is configured to periodically (or upon the occurrence of some recognized event) contact servers to obtain status or test data. If any server does not respond or if a response registers some abnormal condition, ITMD advantageously logs the event and raises an alarm. Depending on the nature of the response (or non-response) ITMD may stop sending any new traffic to the affected server until it resumes normal operation.

Bandwidth Enforcer Module

As mentioned above, the illustrative ITMD bandwidth limiter functionality is split between stateless bandwidth classifier module 340 and stateful bandwidth enforcer module 380. Contract/subcontract Min, Burst, and Max values that define contract terms are expressed in Mbps.

The Min value specifies the minimum bandwidth that is guaranteed under a contract, while the Max value specifies the bandwidth above which packets can definitely be dropped. Burst specifies an intermediate level between Min and Max. All the traffic associated with a particular contract will be sent with a higher priority if the usage level is between Min and Burst. Similarly if the usage is between Burst and Max, the traffic will be sent with a lower priority.

The Min, Burst, and Max thresholds specified under a contract are advantageously rigid in the sense that the unused bandwidth is not shareable across contracts. Under this regime suppose the physical bandwidth is 100 Mbps and each of three existing contracts specify a Min value of 30 Mbps. Then, if there were no flow of traffic for one of these contracts, the bandwidth reserved for it would remain unused rather than being distributed to the other two active contracts. Additional background and examples relating to these and other bandwidth management aspects of the present invention are included in the incorporated application entitled Multi-Level Bandwidth Management.

By way of contrast, subcontracts are advantageously arranged in a hierarchical organization and provide sharing between subcontracts. That is, each contract may be associated with multiple subcontracts. Subcontracts, however, are flexible in that they allow unused bandwidth to be shared across other subcontracts that are subordinate to the same contract. Of course, for the sharing to be meaningful between subcontracts, the sum of the Min Values of all the subcontracts should not be greater than the Min value for the contract to which they are subordinate. In some cases, as in a private network, for example, it may prove useful for accounting purposes to allow a hierarchy of subcontracts, each associated with a location or organization grouping or other meaningful division. In such cases, sharing among subcontracts at any desired level(s), or even among contracts, may prove useful.

As noted above, bandwidth classifier module 340 in the stateless segment of the pipeline of FIG. 3 updates a flow record containing contract/subcontract details tagged to the packet. Bandwidth enforcer module 380 uses these details to perform actual bandwidth management. Specifically, bandwidth enforcer module 380 determines whether a packet is to be transmitted or not based on the contract and subcontract thresholds and existing traffic patterns. If the packet is to be transmitted, it is advantageously assigned either a high priority or a low priority. Bandwidth enforcer module 380 illustratively uses a version of the well-known leaky bucket algorithm to accomplish such bandwidth control.

L2/L3 Egress Processing Module

L2/L3 egress processing module shown as 390 in FIG. 3 forms the last leg of the pipeline. While module 390 is not strictly a stateful module, it is needed by the upper layer modules to transmit packets to the network. The main function of this module is to route the packet to be transmitted. Module 390 also encapsulates the data into an IP header, performs a checksum calculation for the TCP/UDP data and the IP headers. It then encapsulates the packet in the L2 header and transmits the packet. This module shares L2 and L3 configuration with the respective ingress processing modules.

Implementation Alternatives

The pipelined architecture described above is very flexible in its implementation requirements. ITMD can be implemented in software, using a single or multiple CPUs, or in a combination of hardware and software, depending on the throughput requirements. One convenient software implementation uses separate CPUs for the executing software for each of the stateless and the stateful segments of the pipeline.

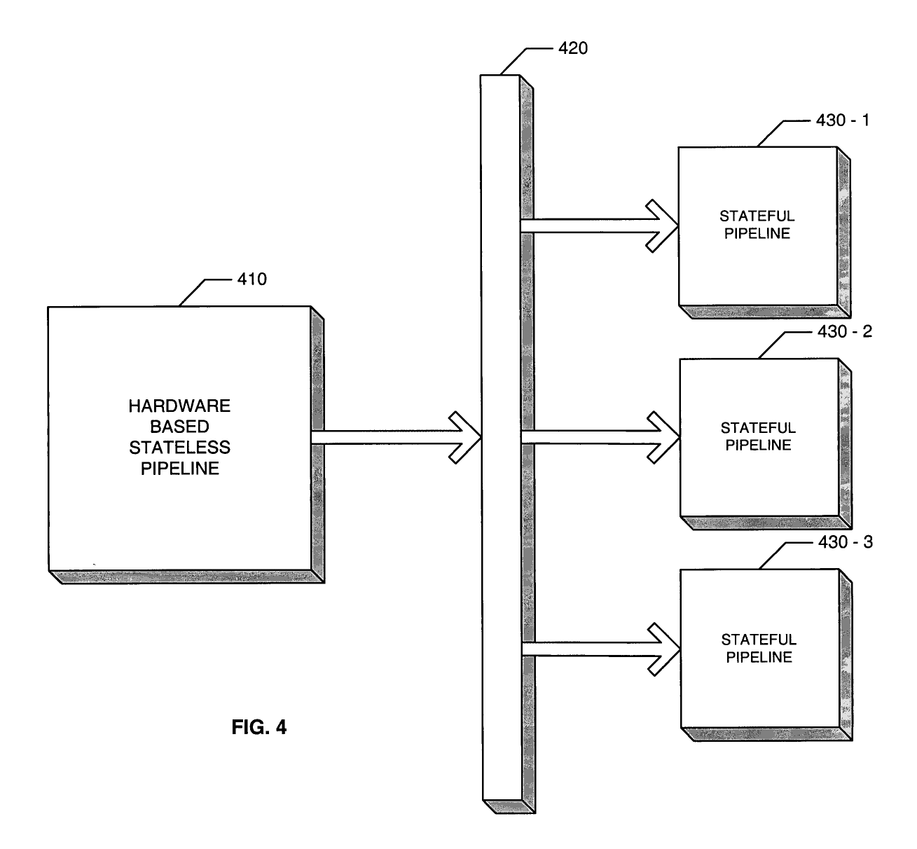

Alternatively, the stateless segment of the pipeline 300 in FIG. 3 can be easily implemented in hardware using a Network Processor or custom designed ASICs or FPGAs to speed up processing. The stateful segment 350 is advantageously implemented in software to provide appropriate flexibility. As shown in FIG. 4, a single hardware assisted stateless pipeline (such as the above-mentioned ASIC or FPGA implementation) 410 can precede multiple software based stateful pipelines, shown as 430-i, i=1, 2, 3. In most configurations of this type, a thin stateful load balancer 420 is used to distribute traffic equally to the respective stateful pipelines 430-i. Normally, the load balancer distributes the load equally amongst the stateful pipelines. In specific cases (e.g. FTP data), a stateful pipeline may instruct the load balancer to direct related new flow(s) to itself. Of course the number of stateful pipeline segments 430-i can be increased to account for high-traffic network contexts. Likewise additional stateless pipeline segments such as 410 in FIG. 4 can be used in a stateless load balancing arrangement to feed load balancer 420.

While packet processing using the present inventive pipeline architectures has been illustrated as integrating and replacing corresponding functions performed at individual middleware nodes in a network shown in simplified form in FIG. 2A, it will be understood that many additional and varied functionalities are readily implemented using the currently described ITMD as expanded to enhance throughput capacity.

Since the present inventive architecture advantageously integrates a number of network functions at a single location, and since embodiments of the single-location architecture are advantageously implemented, at least in part, in program-controlled processors, additions or deletions of particular functions may be made with high efficiency. That is, by merely invoking a particular software module, it is possible to add or delete one or more network function, e.g., a firewall function. Likewise, when particular functionality is implemented as a Field Programmable Gate Array (FPGA) or as an Application Specific Integrated Circuit (ASIC), a simple enabling signal can be selectively applied by a system operator. In appropriate cases, some or all of the functional modules, whether stateless or stateful, will be implemented as programmed general purpose processors or as programmed special purpose network processors such as the Broadcom BCM-1250.

Similarly, newly defined network functions are readily added at the single-location integrated traffic management device (ITMD) in illustrative embodiments. In similar manner, particular network functions can be tailored or reconfigured to meet the needs of particular system users, or classes of users. Thus, one particular version of a firewall function may be applied for one class of users, and a different (or differently configured) version of a firewall may be made available for use with packets of another user or class of users.

Invoking of a software module or enabling of a FPGA, ASIC or other particular hardware or software module can be effected locally by a system administrator in well-known fashion or may be accomplished remotely by sending appropriately coded packets to the inventive single-location integrated traffic management device itself for interpretation and configuration purposes. Thus, with reference to FIG. 4, all-hardware stateless pipelines, such as 410, can be introduced to add system capacity, or particular hardware sub-units within such a stateless pipeline may be added or reconfigured by application of system administrator local or remote inputs. New network functions are therefore readily added by providing appropriate new control program or hardware modules, whether stateful or stateless. Again, new or modified software modules are conveniently delivered to the inventive integrated management device via packets delivered to this device as a destination.

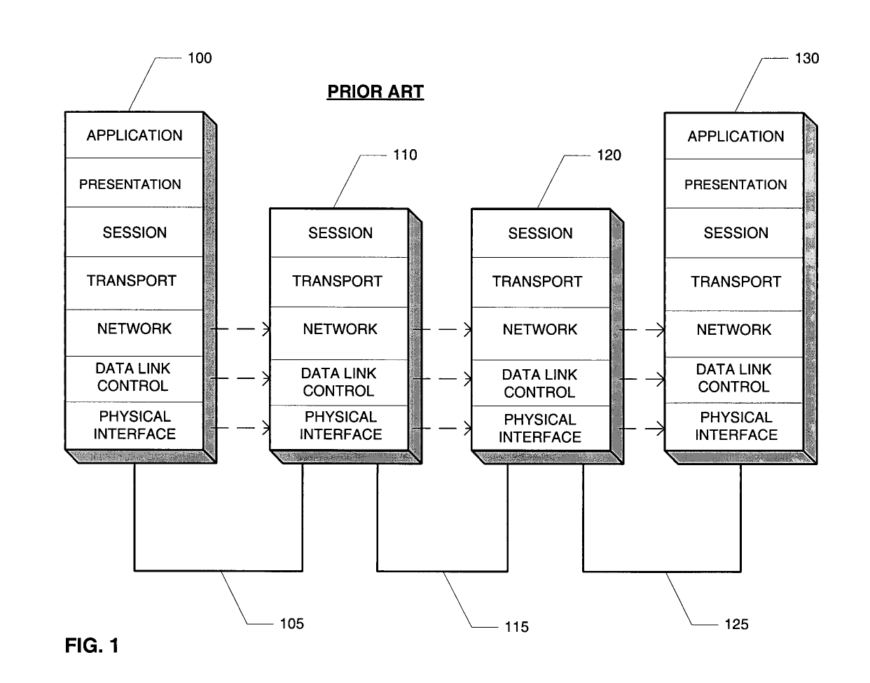

Thus, for example, traffic within and between managed zones as described in the incorporated patent application entitled Creation and Control of Managed Zones will be amenable to processing of the types described above. Thus the present inventive pipelined processor organization will prove useful in performing some or all of the processing functions relating to switching, load balancing, bandwidth management, provision of firewall protections and other functions described in the incorporated patent application entitled Creation and Control of Managed Zones. Those skilled in the art will recognize that the present inventive ITMD represents an alternative to packet scanning and other packet processing functions performed by the TMD 10 described in the latter incorporated patent and shown in FIG. 1 of that incorporated patent application. Example processing described in the latter incorporated application, including that presented in flowchart and pseudo-code form, will prove amenable to execution on a pipelined processor of the types described above in this application. In appropriate cases, an auxiliary processor (such as that shown as 18 in FIG. 1 of the latter incorporated application) may be employed to separate the stateful functions in a network node comprising the above-described ITMD functionalities. Example bandwidth contract terms and parameter values presented in the latter incorporated patent application are likewise of use in further understanding and practicing embodiments of the present invention.

The present inventive teachings focus on the organization and inter-operation of functional modules for integrating functions previously performed in separate stand-alone middleware units. Aspects of well-known hardware and software realizations employed in these stand-alone units will find use in implementing embodiments of the present invention. Thus, for example, well-known load balancing algorithms used in certain existing stand-alone units will be readily adapted for incorporation in integrated packet scanning engines of the types described above. However, while certain features and aspects of processing steps of prior systems will be useful in implementing embodiments of the present invention, those efficiencies achieved by integration of packet processing in the present inventive single-scan pipeline architecture permit avoidance of redundant packet scanning and processing steps.

What is claimed is:

1. A single-pass packet processor for processing received packets comprising
a stateless segment comprising at least one pipelined plurality of stateless functional modules, each of said stateless functional modules performing stateless processing of received packets, and
a stateful segment comprising at least one pipelined plurality of stateful functional modules, each of said stateful functional modules performing stateful processing of packets that have been processed by at least one of said stateless functional units.

2. The single-pass packet processor of claim 1 further comprising a plurality of communications ports for sending and receiving packets.

3. The single-pass packet processor of claim 1 wherein said plurality of stateless functional modules comprises at least one stateless L2 ingress module for mapping an IP address of a received packet to at a corresponding L2 address.

4. The single-pass packet processor of claim 2 wherein said at least one stateless L2 ingress module performs L2 decapsulation of a received packet to derive an IP packet that is made available to at least one other of said stateless or stateful functional modules.

5. The single-pass packet processor of claim 4 wherein said plurality of stateless functional modules comprises at least one stateless L3 ingress module, said L3 ingress module comprising
means for checking the IP header of said IP packet for anomalies,
means for performing IP checksum verification on said IP packet,
means for storing a list of IP addresses associated with said single-pass packet processor, and
means for determining, based on said IP header and said list of IP addresses, whether the examined packet is to be retained at said packet processor or routed to another destination.

6. The single-pass packet processor of claim 5 further comprising
means for determining whether a received packet is to be routed at the L3 layer or switched at the L4 layer when a determination has been made that said received packet is to be forwarded to another destination, and
means for routing said packet to said another destination if forwarding is enabled for said packet.

7. The single-pass packet processor of claim 6 further comprising
means for passing said packet to another functional module in said pipeline when said packet is to be switched at the L4 layer.

8. The single-pass packet processor of claim 7 further comprising at least one stateless firewall module, said stateless firewall module comprising
means for storing firewall rules, each of which comprises a classification and an action, said classification for each packet received at said stateless firewall module being based on selected L3/L4 information in said received packet, and
means for taking an action with respect to each said received packet in accordance with said selected L3/L4 information, said action being selected from the group of actions comprising accept, deny, forward packet to an external host, and copying said packet to an external host.

9. The single-pass packet processor of claim 7 further comprising at least one stateless bandwidth classifier module, said stateless bandwidth module comprising
means for storing contract information associated with received packet flows, said contract information optionally including information relating to a plurality of subcontracts included under a contract,
means for comparing stored contract information with L3 and L4 information in a packet received at said stateless bandwidth module, and
means for entering contract information applicable to a received packet associated with an identified packet flow in a flow record tagged to said received packet.

10. The single-pass packet processor of claim 8 wherein said stateful segment comprises at least one stateful firewall module for receiving packets from said stateless segment, said stateful firewall module comprising means for protecting against L4 denial of service attacks.

11. The single-pass packet processor of claim 10 wherein said stateful firewall module further comprises
means for switching packets between pairs of identified TCP connections or UDP streams.

12. The single-pass packet processor of claim 11 wherein said stateful segment further comprises
an L4 switching module, said L4 switching module cooperating with said firewall module in providing L4 switching of packets, said cooperating comprising identifying pairs of TCP connections or UDP streams to be switched.

13. The single-pass packet processor of claim 12 wherein said L4 switching module further comprises
means for switching received packets to a plurality of servers, and
means for balancing said traffic switched to said plurality of servers to provide a fair share of said traffic to each of said plurality of servers.

14. The single-pass packet processor of claim 10 wherein said stateful segment further comprises
a bandwidth enforcer module comprising
means for receiving from said stateless segment packets and respective associated tagged flow records containing contract information applicable to each received packet, and
means for determining if a received packet is to be transmitted depending on existing traffic patterns at said single-pass packet processor and on contract information tagged to said packet received at said bandwidth enforcer module.

15. The single-pass packet processor of claim 14 wherein said contract information tagged to said packet received at said bandwidth enforcer module includes Min, Burst and Max values for each contract or subcontract associated with a dataflow related to said packet received at said bandwidth enforcer module.

16. The single-pass packet processor of claim 15 wherein said bandwidth enforcer module further comprises
means for determining bandwidth currently committed to each dataflow subject to
received contract or subcontract information,
means for dropping a received packet from a given dataflow when bandwidth currently committed said given dataflow exceeds the Max value for said dataflow.

17. The single-pass packet processor of claim 16 wherein said bandwidth enforcer module further comprises
means for forwarding with higher priority a received packet from a first dataflow when bandwidth currently committed to said first dataflow is at a level between the Min value and the Burst value for said first dataflow, and
means for forwarding with lower priority a received packet from a second dataflow when bandwidth currently committed to said second dataflow is at a level between the Burst and Max values for said second dataflow.

18. The single-pass packet processor of claim 17 wherein said bandwidth enforcer module further comprises
means for sharing available bandwidth allotments between flows associated with subcontracts subordinate to a common contract.

19. The single-pass packet processor of claim 14 wherein said stateful segment further includes a L2/L3 egress module comprising
means for determining the next hop destination address for each packet to be transmitted.

20. The single-pass packet processor of claim 19 wherein said L2/L3 egress module further comprises
means for encapsulating said address data into an IP header, means for deriving checksum information based on available TCP/UDP data and said IP header,
means for encapsulating the packet content, said checksum information and said IP header in an L2 header for transmission.

21. The single-pass packet processor of claim 1 wherein at least one of said stateless functional modules in at least one of said pipelined plurality of stateless functional modules is implemented as an application specific integrated circuit.

22. The single-pass packet processor of claim 1 wherein at least one of said stateless functional modules in at least one of said pipelined plurality of stateless functional modules is implemented as a field programmable gate array.

23. The single-pass packet processor of claim 1 wherein at least one of said stateful functional modules in at least one pipelined plurality of stateful functional modules is implemented as a programmed processor.

24. The single-pass packet processor of claim 1 wherein at least one of said stateful functional modules in at least one pipelined plurality of stateful functional modules is implemented as a programmed network processor.

25. The single-pass packet processor of claim 1 wherein at least one of said stateful pipelined plurality of stateful functional modules is selectively enabled by control signals applied to said single-pass packet processor.

26. The single-pass packet processor of claim 25 wherein at least one of said stateful pipelined plurality of stateful functional modules is implemented as a coded module executed by said programmed network processor.

27. The single-pass packet processor of claim 1 wherein at least one of said stateless pipelined plurality of stateless functional modules is selectively enabled by control signals applied to said single-pass packet processor.
